(19) United States
(12) Patent Application Publication
(10) Pub. No.: US 2010/0146043 A1
(43) Pub. Date: Jun. 10, 2010

(54) METHOD AND SYSTEM FOR DISTRIBUTING INCOMING DATA

(76) Inventor: Markus Klopf, Langenlois (AT)

Correspondence Address: DICKSTEIN SHAPIRO LLP, 1825 EYE STREET NW, Washington, DC, 20006-5403, US

(21) Appl. No.: 12/576,701

(22) Filed: Oct. 9, 2009

(30) Foreign Application Priority Data
Oct. 9, 2008 (AT) A 1585/2008

(51) Int. Cl. G06F 15/16

(52) U.S. Cl. 709/203

(57) ABSTRACT

The invention relates to a method and a system for distributing incoming data (1) via servers to at least one client (9). According to the invention, it is provided that the incoming data (1) are fed to an active server (2) and to at least one further server (3) at a preset time delay (Δt).

The invention relates to a method for distributing incoming data according to the preamble of claim 1, and to a system for distributing such data according to the preamble of claim 6. Methods and systems of this type are used in traffic control technology, in particular in high security sectors such as e.g. air traffic control.

Within the meaning of the subject invention, data is deemed to be aviation-relevant data or traffic data of the most general type, in particular, position and control data such as e.g. altitude of aircraft, landing clearance or the correlation between aircraft and controller. Furthermore, these also include all data which is exchanged between controllers and pilots for regulating air traffic, i.e. also weather data, topographic data, etc.

All interferences, breakdowns and malfunctions of one or more computers which occur during the communication are deemed to be an error condition. In particular, these include system crashes such as crash, reboot or freeze.

A fundamental problem for the proper functioning of the transmission and distribution systems for the aforementioned data lies in that defective, damaged, garbled, manipulated or distorted incoming traffic data reach a central distribution system and cause an error condition in said distribution system in the course of processing.

Typically, defective data or harmful data of this type can reach the system through a number of malfunctions of the sending devices or transmitting devices and also through weak points in the security sector, perhaps during intentional attacks by third parties. Usually, however, harmful or defective data exists in data which were distorted by malfunctions or incorrectly produced.

This problem can not be overcome by simple duplication of the processing systems or server in question for the distribution, since the incoming data are forwarded to all arranged in parallel servers and an error condition occurs almost at the same time in said servers. The mutual monitoring of the individual servers is also only successful up to a point in a case of this type, as the error conditions of the individual servers are or occur within a limited time range.

A problem of this type is remedied by variably constructed or programmed servers having the same functionality, as it can most likely be assumed that, when there are defective data and they are processed in variably constructed servers, the same error condition does not occur in all servers. However, the multiple implementation of security-critical server applications is extremely expensive, in particular personnel-intensive and time-consuming.

The object of the invention is to overcome the aforementioned problems and to create a method and a system for distributing incoming data which solve the aforementioned problems.

The invention solves this object with the characterizing part of claim 1 and the characterizing part of claim 6. According to the invention, the advantage is that, when there are error conditions in the active servers, the further servers have a predefined window of time within which an error condition of the further servers can be effectively avoided or prevented by the delayed data transmission. As a result of this precautionary measure, security measures can be taken in the remaining servers during this window of time to prevent error conditions of the entire system.

An especially advantageous manner of dealing with these errors is made possible by the features of claims 2 and 7. After the function of the active server has been taken over by one of the further servers, the system continues to function without restrictions and an error condition of the entire system is prevented.

The feature of claim 3 enables the resumption of the normal operation. When the distribution function is taken over by a further server and the server which has been identified as malfunctioning is restarted or restored, the time period within which the system is not available for clients is limited to that time period which is required for detecting and switching between two servers. The change-over times are relatively short and can be freely or randomly selected.

With the features of claims 4 and 11, a distribution of the incoming traffic data to clients can be obtained in which the reproduction of defective or harmful information to the clients is effectively prevented.

The features of claims 5 and 13 enable a secure identification of error conditions with quick disconnection of the active server and, at the same time, the data loss is kept slight.

The features of claim 8 enable a joint preprocessing of the incoming data for all servers. This results in a simplified adaptation of a system according to the invention to a number of different protocols and standards.

A system according to claim 9 offers increased crash security by duplication of the components.

A system according to claim 10 offers an especially compact construction and prevents the transmission of defective data to further servers.

With the features of claim 12, an especially compact structure of the system according to the invention is obtained by integrating several components in individual servers. By means of this preferred embodiment, a server used for monitoring is designated which controls the activity of the respective active server.

The drawing schematically shows the construction or the data paths in a system according to the invention for traffic data distribution according to the best known embodiment.

The system shown in the Fig. comprises an active server 2 and two further servers 3. An interface adapter 7, in which incoming data 1 are preprocessed, is connected upstream of the active server 2. Incoming data are made available by external providers, e.g. a radar system. Optionally, protocol conversions can be undertaken with the interface adapter 7 to ensure a compatibility of the server with the incoming data 1. One of the servers 3 is designated as active in each case. This is the only server which is in communication with the client. The further servers receive the incoming data in a time-deferred manner and do not interact with the clients or with one another.

The data 1 preprocessed in the interface adapter 7 are forwarded to the active server 2 and distributed to a multitude of clients 9 from there, perhaps in response to a query. As soon as data 1 has been forwarded to the active server 2 and stored in it, this data can be queried by the clients 9. The use of an interface adapter 7 is not imperative. The active server 2 can also be fed directly by the incoming data 1 and/or each server can have its own interface adapter.

The data arriving in the active server 2 are not only held available for query by the clients 9, but also transmitted to the delay unit 8 which is provided in the active server 2 in this special embodiment. Of course, a delay unit 8 which is situated outside of the active server, e.g. as an autonomous component, can also be provided or the interface unit 7 can comprise a delay unit 8 and consequently two different outlets for data 1 which has been transmitted in a delayed manner and in a non-delayed manner. However, in a delay unit 8 implemented in the active server 2, there is the advantage that defective or harmful data 1, which perhaps cause the error condition of the active server 2, are in any event deleted when the active server 2 is restarted.

The transmission of the data 1 is delayed in the delay unit 8 for a given time interval or delay time Δt. This means that, at the outlet of the delay unit 8, the incoming data 1 with a preset delay time Δt, in particular in the range of between 2 seconds and 15 minutes, are delivered at the outlet. The delay time Δt can also be adapted to the respective system conditions by an adaptive mechanism.

Furthermore, however, to protect clients 9 against defective or harmful data 1, it can be provided that the data 1 can only be queried by the clients 9 after a preset time interval.

The delay time Δt is, in particular, independent of the preset time interval between the arrival of the data 1 at the active server 2 and the availability of the data for the clients 9, advantageously, the delay time Δt is selected shorter than this time interval.

The outlet of the delay unit 8 is connected to the inlets of the further servers 3. In this way, it is attained that the incoming data 1 are conveyed to all further servers 3 after a preset time delay Δt. However, to carry out the method according to the invention, only one further server 3 is absolutely necessary.

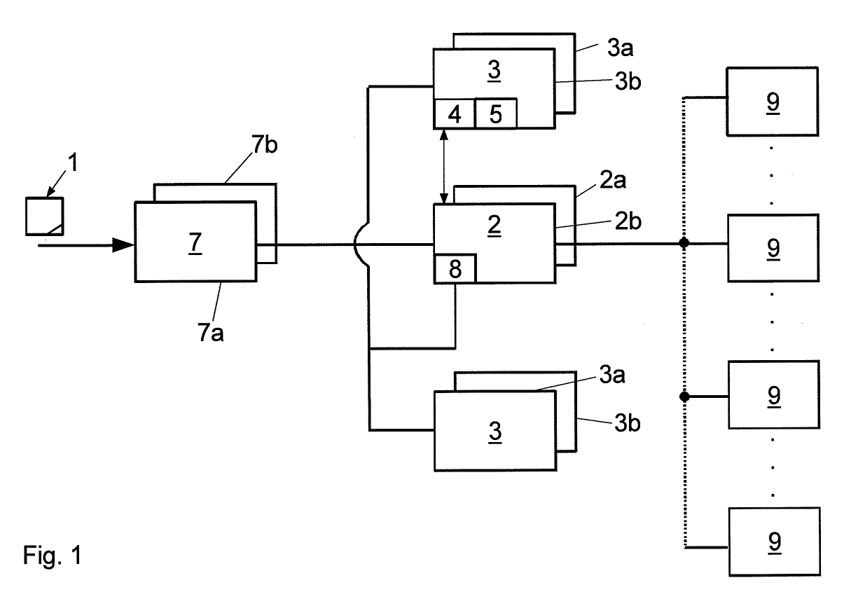

In the embodiment shown in FIG. 1, one of the further servers 3 comprises a fall-back unit 4 for identifying an error condition of the active server 2, and an activation unit 5 for switching one of the further servers 3 to function as active server 2 in the case of an error condition of the active server 2.

In this case, the fall-back unit 4 can be equipped as a query unit which queries the active server 2 at preset intervals, in particular within the preset delay time Δt, whereby, once the active server 2 has responded, one can conclude that it is operating correctly. However, if there is an error condition in the active server 2, it can not respond to the query or it can only provide a non-appropriate protocol response and an error condition is identified. All available identification systems and methods are possible for the identification of an error condition. For example, each server 2, 3 can also have an identification unit at its disposal which emits a signal to the fall-back unit 4 in the case of an error condition. Advantageously, each server comprises a fall-back unit 4 of this type.

After identifying the error condition of the active server 2, the fall-back unit 4 triggers an activation unit 5 which switches one of the further servers 3 to active, as a result of which it now functions as an active server 2. In principle, it is irrelevant which of the further servers 3 is activated in the event of an error condition of the active server 2. However, it is important that one of the further servers 3 is determined in advance for this purpose. To this end, the address of the server to be activated can be stored in a storage unit in the respective activation unit 5. In the event of an error condition of the active server 2, that further server whose identification or address is stored in said storage unit is activated by the activation unit 5.

In a preferred embodiment, the delay time Δt is between 2 seconds and 15 minutes. A lower limit for the delay time Δt in the second range is advantageous as, in this case, there is sufficient time available for the fall-back unit 4 or activation unit 5 set in a further server 3 to identify the crash and to optionally activate a further server 3. An upper limit in the range of several minutes is based on the fact that the data loss due to an error condition should be kept as slight as possible. Depending on the application, a balance can be met between the failure security and the magnitude of the data quantity affected by the data loss.

In a preferred embodiment, it can be provided that the same software is stored on all servers 2, 3. Programs are stored on each server 2, 3 which implement the function of the fall-back unit 4, the activation unit 5 and/or the delay unit 8. Furthermore, a data storage unit is provided on every server for storing data 1 on the server and a data distribution unit for distributing data to the clients 9, in particular in response to a query, by broadcast or by multicast, the function of which is also implemented by a program.

One of the servers of the system according to the invention functions as an active server 2 or is switched to active. Those programs which realize the function of the delay unit 8, the data storage unit and the data distribution unit run on this active server 2. By starting the respective program, the active server 2 thus has command of the said units or functionality.

Those servers which do not function as active servers are called further servers 3. One of the further servers 3 functions in the embodiment shown in the Fig. as a monitoring server. Those programs which implement the function of the fall-back unit 4, the activation unit 5 and the data storage unit run on said monitoring server. The activation unit 5 possesses a storage unit in which the address or identification of said further server 3 is stored which is to be activated in the event of an error condition.

Further fall-back units 4 which trigger the activation unit 5 can also be provided in all further servers 3 and, in particular, also in the active server 2.

The further servers 3 each have a data storage unit and, optionally, a fall-back unit 4 whose function is realized by a computer program implemented on the further server 3.

It can be provided that, in the event of an error condition of the active server 2, the previously designated monitoring server is activated or that it assumes its function. Another one of the further servers 3 then assumes the role of the monitoring server. In this case, the computer program implementing the function of the activation unit 5, optionally also the computer program implementing the function of the fall-back unit 4, is terminated in the server now activated, however, instead, the computer programs implementing the function of the delay unit 8 and the data distribution unit are started. After this program has been started, this server functions as new active server 2.

In one of the further servers 3, optionally also in the server newly started due to an error condition, that program is started which implements the activation unit 5. Furthermore, in the event that no fall-back unit 4 was implemented on the monitoring server, that program which implements the fall-back unit 5 is also started.

The embodiment of the active server 2, the further server 3 and the interface adapter 7 , each as a multitude of similarly constructed individual units, in particular individual servers 2a, 2b; 3a, 3b, and individual interface adapters 7a, 7b, is especially advantageous. It is thus obtained that the crash probability is reduced based on the duplication.

The delay unit 8, the fall-back unit 4 and the activation unit 5 can be alternatively provided as autonomous components connected to the servers 2, 3.

1. A method for distributing incoming data (1), in particular air traffic data, via servers to at least one client (9), characterized in that the incoming data (1) are conveyed/fed both to an active server (2) and also to at least one further server (3) at a preset time delay (Δt).

2. The method according to claim 1, characterized in that, in the event of the detection of an error condition of the active server (2), the further server (3) or one of the further servers (3) takes over the role of an active server (2) and that the incoming data (1) is transmitted free from delay or without a time delay to said activated server (2) from the point in time of the detection.

3. The method according to claim 2, characterized in that the active server (2), after detection of the error condition and its re-establishment or its restart, functions as further server (3) or one of the further servers (3) and receives the data (1) in a time-delayed manner.

4. The method according to claim 1, characterized in that the clients (9) receive data (1) exclusively from the respectively active server (2) to which the incoming data (1) are fed without delay.

5. The method according to claim 1, characterized in that a time delay (Δt) between 2 seconds and 15 minutes is selected and, in particular, that it can be adjusted freely by the user or is variable according to random criteria.

6. A system for distributing incoming data (1) to at least one client (9), characterized in that
a) the system comprises at least two servers (2, 3), including an active server (2) to which the incoming data (1) are directly fed,
b) the system comprises a delay unit (8) to which the incoming data (1) are also directly fed, and
c) the data (1) adjacent to the outlet of the delay unit (8) are fed to the remaining servers (3).

7. The system according to claim 6, characterized in that
a) the system comprises at least one fall-back unit (4) for identifying an error condition of the active server (2), and that
b) the system comprises an activation unit (5) for active switching of one of the remaining servers (3) as active server (2) after detection of an error condition of the active server (2) by the fall-back unit.

8. The system according to claim 6, characterized by an interface adapter (7) for formatting the incoming data (1), wherein the outlet of the interface adapter (7) is connected to the active server (2) and to the delay unit (8).

9. The system according to claim 6, characterized in that at least one server (2, 3), preferably every server (2, 3), comprises a multiple of individual servers (2a, 2b; 3a, 3b), in particular similarly constructed, wherein the individual servers (2, 3) are preferably structured the same.

10. A system according to claim 6, characterized in that computer programs which implement the function of the delay unit (8), the fall-back unit (4) and/or the activation unit (5) are stored or installed on all servers (2, 3), wherein, during operation of the active server (2), the function of the delay unit (8) is realized by a computer program running on said active server (2) and, during operation on one of the further servers (3), the function of the activation unit (5) and/or the fall-back unit (4) is realized by a computer programm running on this further server (3).

11. The system according to claim 6, furthermore comprising at least one client (9), characterized in that the client (9) is exclusively connected to the active server (2) for the data transmission.

12. The system according to claim 6, characterized in that the fall-back unit (4) and the activation unit (5) are present or realized, in particular, in the same further server (3), and the system optionally comprises a storage unit for an identification or address of the server (3) to be activated in the case of an error condition.

13. The system according to claim 6, characterized in that the time delay (Δt) is between 2 seconds and 15 minutes and, in particular, can be adjusted freely by the user or is randomly variable.
